(19) United States
(12) Patent Application Publication
(10) Pub. No.: US 2013/0166466 A1
(43) Pub. Date: Jun. 27, 2013

(54) SOCIAL NETWORKS AND CAREER MANAGEMENT

(71) Applicant: Joan SANGER, Waterloo (CA)

(72) Inventor: Joan SANGER, Waterloo (CA)

(21) Appl. No.: 13/727,564

(22) Filed: Dec. 26, 2012

Related U.S. Application Data
(60) Provisional application No. 61/578,878, filed on Dec. 22, 2011.

(51) Int. Cl. G06Q 10/10; G06Q 50/00

(52) U.S. Cl. CPC G06Q 10/1053; G06Q 50/01
USPC 705/319

(57) ABSTRACT

Computer and mobile digital communication device users share career, vocational, self-employment, and/or volunteer position information in order to receive career planning. Users receive assessments and/or evaluations and manage their educational and/or career development paths. Jobs that are suitable for the user being evaluated are determined in relation to the career interests of the user. The current educational level of the user is matched to the job to identify gaps in at least one of educational or skill prerequisites to attaining the job. Then, resources, such as classes, publications, educational training programs or internship programs, are offered to the user being evaluated to fill in the gaps. To defray the cost of making such resources available to the user, a pool of users of the social network are notified and given the opportunity to be responsible for gifting one or more of the identified resources to the user being evaluated.

### FIELD OF THE INVENTION

This is an invention to allow computer and mobile digital communication device users to share and/or work on their career, vocational, self-employment path and/or volunteer position and/or assist others in doing the same. Users assess and/or evaluate and manage their educational and/or career development independently, with selected friends and/or colleagues in their social networks and/or then selectively with other users of social media and/or potential employers and/or career and/or educational service providers. The invention allows interactivity based on identifying and/or assessing and/or evaluating career or vocational interests, desires, skills, abilities, barriers, and/or activities.

### SUMMARY

Some of the shortcomings of the prior art in career management and self-employment are addressed through new methods and systems to integrate individual career planning into social networks of friends, mentors, employers, educators and others. A timeline application and/or also similar timelines and/or other computer and/or mobile digital device communication applications, including those on various social networks operating under the trademark names LINKEDIN, GOGGLE GROUPS, GOGGLE+, and other digital software shared among users on computer and/or mobile digital devices are also utilized.

### DETAILED DESCRIPTION

In various embodiments, the invention takes what each social media user is doing to reflect on his or her life back in his or her timeline or other timeline types of software, and personalizes a path or vision forward, by incorporating the past and present into his or her future vision. The invention allows users to create and record work-related success stories in videos, writings and pictures, as well as allowing the development of the success stories to be done with the assistance of those in their social network. In various embodiments, the invention creates or uses an existing timeline, and guides them in mapping past success stories to future opportunities.

Algorithms for dynamic data, that includes user-identified and/or assessed transferable skills, desires, talents, barriers, goals, abilities, challenges, interests and/or desires, are utilized to match users to their most ideal business and/or company culture, career, vocation, volunteer positions, self-employment and/or education.

In various embodiments, Internet semantic searches are used to match the user to the appropriate career, volunteer activity, self-employment and/or education experiences will be based on self- identified and/or assessed (and/or semantically automatically generated) hobbies, education, desires, goals, talents, barriers and/or environmental limitations, and/or interest assessments and/or surveys and/or interactive exercises. Gaps in information on, or real past experience in, career information, volunteer activity, self-employment and/or education experiences, hobbies, education, desires, goals, talents, barriers, environmental limitations, and/or interests will be identified and/or addressed.

In various embodiments, a continuum positioning game allows users to engage one another by asking them to rate one another on the continuum from artistic, social, enterprising, investigative, realistic, and conventional, as well as the related jobs to these categories, with scores for correctly guessing friends' positions. In various embodiments, friends, colleagues and/or mentors will participate in a guessing game based on matched job tasks, relevant skills, abilities, knowledge areas and/or work activities and/or self-identified hobbies, education, desires, goals, talents, barriers and/or environmental limitations, and/or interest assessments and/or surveys and/or interactive exercises. Gaps in information on, or real past experience in, career information, volunteer activity, self-employment and/or education experiences, hobbies, education, desires, goals, talents, barriers, environmental limitations, and/or interests will be identified and/or addressed.

In other embodiments, users have access to static job data. This data includes the accompanying video, all job tasks, relevant skills, abilities, knowledge areas and work activities for jobs and can be in multiple languages for the user to re-rank for his or her past experiences. In various embodiments, users are provided shared and differing skills for jobs and guided to engage mentors and/or friends to comment on their path and/or plans, including LinkedIn and/or other social media forums and connections. In other embodiments, users and/or companies can submit videos which are specific to a certain job and/or workplace. People managing their careers through career websites can find those companies within their job search area that have hired, for the type of job that they want, in the past (even if the company currently does not have a posting). The invention includes, in various embodiments, semantic software job title and/or description matching for career management and planning, including suggestions for career and/or business startup matches with static suggestions and/or actual opportunities potentially available to the users, which may include interest and/or desire and/or other assessments completed by the user to trigger the semantic search. In various embodiments, the data collected from the assessments and/or surveys and/or exercises to determine interests and/or desires, and/or data regarding job tasks, relevant skills, abilities, knowledge areas and/or work activities and/or self-identified hobbies, education, desires, goals, talents, barriers and/or environmental limitations, is mined and/or stored for other applications and/or third party usage. In other embodiments, the matching includes cross-walking transferable interests, educational backgrounds, skills, abilities and/or knowledge to the careers, self-employment options for static data and/or actual opportunities available.

Additionally, internal forums with friends on FACEBOOK, LINKEDIN and/or other social media forums, in multiple or single languages, segmented by jobs or education or location, are part of the invention. The invention allows and captures job descriptions, built by the members themselves and has the ability to incorporate links for Facebook, LinkedIn, and/or other social tools and/or forums on a computer and/or mobile digital device and incorporate these links on a vision board and/or mind map. Users have the ability to place one or multiple specific jobs and/or companies on their new future timeline, vision board and/or mind map. Various embodiments include segmentation of contacts by industry and/or educational interests and/or achievements.

Embodiments of the invention include the creation of a gift package for parents and grandparents of career management programs. Various embodiments include building company culture-specific data from feedback from users on actual jobs in social network forums on computers or mobile digital devices, as well as workplace leadership tools for use in social networking internal or external to companies or organizations and/or for use by individuals and/or their connections in social networks on their computers or digital mobile devices

In one embodiment, the social network user will complete one or more career interest assessment to match them with Holland Codes for jobs related to their career interests, and then the user will be matched with their current educational level to identify gaps and needed education as well as other needs related to location, financial restraints, time restraints or other barriers to attaining those resources. Resources from outside vendors and others will be brought in to be chosen by the user and or their friends and or social network mentors and or acquaintances and or family to pool gifts for those matched resources. Those matches will determine the gift options for the social network and others identified by the user to potentially be part of a gift pool.

In one embodiment, the user of the social network platform will complete one or more career skills assessment to match them with jobs related to their career skills, and then the user will be matched with their current educational level to identify gaps and needed education as well as other needs related to location, financial restraints, time restraints or other barriers to attaining those resources. Resources from outside vendors and others will be brought in to be chosen by the user and or their friends and or social network mentors and or acquaintances and or family to pool gifts for those matched resources. Those matches will determine the gift options. Those matches will determine the gift options for the social network and others identified by the user to potentially be part of a gift pool.

In one embodiment, the user of the social network platform will complete one or more career soft skills assessment to match them with jobs related to their skills, and then the user will be matched with their current educational level to identify gaps and needed education as well as other needs related to location, financial restraints, time restraints or other barriers to attaining those resources. Resources from outside vendors and others will be brought in to be chosen by the user and or their friends and or social network mentors and or acquaintances and or family to pool gifts for those matched resources. Those matches will determine the gift options. Those matches will determine the gift options for the social network and others identified by the user to potentially be part of a gift pool.

In one embodiment, the user of the social network platform will complete one or more workplace motivational evaluations to match the user with jobs, and then the user will be matched with their current educational level to identify gaps and needed education as well as other needs related to location, financial restraints, time restraints or other barriers to attaining those resources. Resources from outside vendors and others will be brought in to be chosen by the user and or their friends or social network mentors and or acquaintances and or family to pool gifts for those matched resources. Those matches will determine the gift options. Those matches will determine the gift options for the social network and others identified by the user to potentially be part of a gift pool.

In one embodiment, the user of the social network platform will complete one or more self-employment career assessment to match them with jobs related to their self-employment interests, and then the user will be matched with their current educational level to identify gaps and needed education as well as other needs related to location, financial restraints, financing of the business, writing a business plan, understanding the market identified, building a team, and executing on a business plan, time restraints or other barriers to attaining those resources. Resources from outside vendors and others will be brought in to be chosen by the user and or their friends and or social network mentors and or acquaintances and or family to pool gifts for those matched resources. Those matches will determine the gift options. Those matches will determine the gift options for the social network and others identified by the user to potentially be part of a gift pool.

In some embodiments, the social network may automatically suggest a list of resources to the user being evaluated for selection as a gift. As an alternative, the user being evaluated may make a request of the social network to provide a list from which the resource can be chosen as a potential gift. Additionally, in some embodiments, the user being evaluated may browse a gift store webpage to select the resource, or make an auction bid for the resource within the social network environment. Other users, for example within the pool of users making a gift of the resource available to the user being evaluated, may be given an option for approval of the selected gift, by voting for example. The user's responses to and results of the assessments and evaluations and resulting relevant information may be offered to institutions providing the resources, such as marketing companies, manufacturers, publishers, and educational vendors and educational institutions, through social network channels.

Although several examples of assessments have been described, any one of the assessments or any combination thereof may be used in the foregoing embodiments. The assessments and evaluations may be tailored to or administered by a potential resource provider, such as a marketing company, manufacturer, publisher, or educational vendor/ institution.

Further, the resources may be one or more classes or technical courses, as well as a publication, educational training program or internship program, and these may be offered individually by one provider or offered sequentially or in parallel by mone or more providers according to the job desired to be attained. Given these embodiments, a gift package to purchase the matched educational resources can be offered to the user via a pool of users of the social network, thereby to reach a goal of the total purchase price of the gift for the matched resource or resources.

1.-2. (canceled)

3. A method of creating a life planning map, the method comprising:
a user who is a member of a social network that includes a plurality of other users,
a profile, unique to the user, for displaying user generated information and assistance generated information, the user generated information and the assistance generated information each contain events relating to a user's life activities and is available for the plurality of other users to view,
generating, by the user, the user generated information based on the user's personal knowledge,
generating, by the plurality of other users, individually or in combination, the assistance generated information based on the personal knowledge of each of the respective plurality of other users, communicating the assistance generated information to the user,
maintaining the events of the user generated information and the assistance generated information in chronological order,
generating, by a life planning algorithm, a projected life planning map based on the user generated information and the assistance generated information,
matching the projected life planning map with a plurality of career possibilities to develop a prospective career for the user.

4. The method of claim 3, comprising:
soliciting, by the user, one or more of the plurality of other users via the social network to generate and communicate the assistance generated information.

5. The method of claim 4, comprising:
the solicitation asks for information from the other users about an event relating to the user's life activities specified by the user,
the other user assistance generated information, generated by the other users solicited, includes opinions about the user formed as a result of the event relating to the user's life activities.

6. A method of job searching, the method comprising:
a user and a database of companies, each connected to a job matching service between the user and a job,
the user performing an assessment test,
acquiring assessment test results as a result of performing the assessment test,
upon the user acquiring assessment test results, searching, by semantic software using the assessment test results for a job within a company of the database of companies, and
matching the user with a company.

7. The method of claim 6, comprising:
the assessment test assesses career interests of the user.

8. The method of claim 6, comprising:
the assessment test assess career skills of the user.

9. The method of claim 6, comprising:
the assessment test assess career soft skills of the user.

10. The method of claim 6, comprising:
the assessment test assesses self-employment career interests of the user.

11. The method of claim 6, comprising:
the user and a plurality of other users are members of a social network,
soliciting opinion information relating to a company via the social network from the other users,
organizing the opinion information on the social network,
acquiring company specific data from the users relating to traits of a company,
searching, by semantic software, using the assessment test results, company specific data, a user defined job description, or generic job description for a currently available job or potentially available job within a company,
matching the user with a company based on matching the company specific data and opinion information relating to the company and targeting companies that have hired in the past for similar job positions that the user desires.

12. A method of determining gifts for a user, the method comprising:
the user and a plurality of other users are members of a social network;
determining an education gap between the user's current education and the education required for a desired job or career path of the user;
determining needs or challenges of the user to be fulfilled by resources to achieve the education required for the desired job;
the user, choosing via the social network, a vendor from among a plurality of vendors to provide resources to the user to fulfill the determined needs;
providing the resources from the vendor to the user that satisfy needs to acquire the education required for a desired job or career path of the user as gifts to the user.

13. The method of claim 12, comprising:
the needs of the user comprise financial restraints, location restraints, time restraints and other personal challenges or barriers.

14. The method of claim 12, comprising:
wherein, each vendor has gift options available that correspond to one or more resources, Preliminary Amendment filed April 9, 2013 choosing, by the user, a gift option for a gift.

15. The method of claim 12, comprising:
choosing, by the other users or by the user,
vendors to provide gifts to the user,
choosing, by the other users, gifts from a chosen vendor,
pooling the gifts chosen to provide one or more gifts to the user.

16. The method of claim 15, comprising:
wherein the other users are grouped into groups, at least one of the groups is comprised of family members of the user,
at least one of the groups is comprised of member users of the social network specified by the user.

17. The method of claim 12, comprising:
determining an education gap between the user's current education and the education required for a desired self-employment interest;
determining needs of the user to be fulfilled by resources to achieve the education required for the desired self-employment interest;
providing the resources from the vendor to the user that satisfy needs to acquire the education required for a desired self-employment interest of the user as gifts to the user.

18. The method of claim 17, comprising:
the needs of the user further comprise financing of the business related to the self-employment interest, addressing personal barriers or restraints, writing a business plan, understanding an identified market related to the self-employment interest, building a team, and executing a business plan.

19. The method of claim 17, comprising:
choosing, vendors to provide gifts to the user,
choosing, by the other users, gifts from a chosen vendor,
pooling the gifts chosen by the user and the other users to provide one or more gifts to the user.

20. The method of claim 12, comprising:
the social network suggests a list of resources for each need of the user,
each user of the social network votes for a resource to be used for a need.

21. The method of claim 19, comprising:
the chosen vendor pools all gifts of the resources provided by the vendor.
